(19) United States
(12) Patent Application Publication
(10) Pub. No.: US 2023/0211739 A1
(43) Pub. Date: Jul. 6, 2023

(54) EQUIPMENT COMPONENT FOR A VEHICLE

(71) Applicant: GRAMMER AG, Ursensollen (DE)

(72) Inventor: Ralph NUSS, Poppenricht (DE)

(21) Appl. No.: 18/084,818

(22) Filed: Dec. 20, 2022

(30) Foreign Application Priority Data
Dec. 21, 2021 (DE) 10 2021 134 098.5

(51) Int. Cl. B60R 11/02; B60N 2/75; B60N 2/879; F16H 19/04; F16H 25/20; H04R 1/02

(52) U.S. Cl. CPC B60R 11/0217; B60N 2/763; B60N 2/879; F16H 19/04; F16H 25/20; H04R 1/02; F16H 19/06

(57) ABSTRACT

An equipment part for a vehicle, including a wing device having at least one wing. The wing is pivotably about a pivot axis between a first pivot position and a second pivot position. The wing has a base part and an extension part that is supported movably relative to the base part in a translatory manner between a base position and an extended position. An adjusting device has at least one motor drive and a transmission for executing the pivoting movement as well as the translatory movement of the wing. By way of the transmission, a conversion takes place of a rotary movement of the drive to a translatory movement of the extension part, wherein a torque about the axis of rotation is produced in the base part, with which torque the wing is pivotable between the first pivot position and the second pivot position.

The invention relates to an equipment part for a vehicle. A vehicle in the sense of the invention can be a land, air or water vehicle.

An equipment part of this kind is known from obvious prior use. In the obvious prior use, the equipment part is a headrest. The headrest comprises a head part, on which a wing is mounted pivotably on both side regions. The headrest had a motor drive for joint pivoting of both wings as well as a motor drive in each case for the translatory movement of an extension part of the wing relative to a base part. What could be improved in this prior art was the high cost outlay and control effort for the motor drives. These also gave rise to a high weight.

The object of the invention was to create an equipment part in which the same functions, i.e. also the pivotability and translatory movement of an extension part relative to a base part, can be guaranteed with less expense.

The object was achieved by a drive device with the features of claim 1.

The equipment part comprises at least one wing, in particular two wings. The wing is pivotable relative to a base about a pivot axis between a first pivot position and a second pivot position and comprises a base part and an extension part, which is movable relative to the base part in a translatory manner between a base position and an extended position. In the base position, the base part and the extension part are arranged nested. In the extended position, the extension part is moved relative to the base part into an extended-out position. The length of the wing in the extended position is greater with respect to the base position. A movement of the wing between a non-use position and a use position is composed of the movement of the entire wing between the first pivot position and the second pivot position and of the movement of the extension part relative to the base part between the base position and the extended position.

The pivoting movement of the wing and the translatory movement of the extension part relative to the base part takes place by means of a drive device comprising at least one motor drive and a transmission. The pivoting movement and the translatory movement take place e.g. consecutively. E.g. first the pivoting movement takes place and then the translatory movement. Alternatively, the translatory movement can take place first and only then the pivoting movement.

The conversion of a rotary movement of the drive shaft to a translatory movement of the extension part relative to the base part of the wing takes place by means of the transmission. The transmission is designed in such a way that it produces in the wing a torque about the rotary axis with which the wing is pivotable between the first pivot position and the second pivot position. In other words, the torque arising on conversion of the rotary movement to a translatory movement is used to pivot the wing.

During the pivoting movement of the wing there is e.g. no relative movement between base part and extension part. The pivoting movement and the translatory movement take place e.g. separately. E.g. the movement takes place from the non-use position to the use position in which first the pivoting movement and then the translatory movement takes place. The movement from the use position to the non-use position takes place e.g. by performing first the translatory movement and thereafter the pivoting movement.

The sequence of movements, i.e. pivoting movement and translatory movement, can be controlled by means of a control device with at least one control means. At least one control means is formed e.g. by a spring.

Because the transmission for driving the translatory movement also produces a torque for pivoting the wing, it is not necessary to provide separate motors for the pivoting movement and for the translatory movement of the wing. This results in a reduction in the outlay for the control and a cost saving. Moreover, this solution is accompanied by a weight saving due to the reduction in the motor drives.

The base part is mounted on the base e.g. pivotably about a pivot axis. The at least one wing then forms a pivot joint with the base. If two wings are provided on the base, e.g. a central drive shaft can be formed in the base that drives the pivoting movement of both base parts. The central drive shaft drives e.g. the pivot shaft of the wing directly or indirectly.

The base part of the wing forms a pivot joint e.g. with the pivot shaft. The base part is mounted pivotably e.g. on the pivot shaft.

The pivot shaft is e.g. the drive shaft of the drive device at the same time. The pivot shaft can be driven e.g. by the drive shaft.

The drive shaft of the wing has e.g. first drive means, which introduce a torque in the base part and interact with second drive means of the extension part of the wing in order to execute the translatory movement. The first drive means cause a torque in the base part, which torque causes the rotatory movement of the wing. For example, a gearwheel connected fixedly to the drive shaft meshes with a rack rail of the wing. The rotary movement of the gearwheel causes the rotary movement of the base part and thus of the wing. The rack rail is associated with e.g. the extension part of the wing. The rotation of the gearwheel, which meshes with the rack rail, causes the extension movement.

The transmission device comprises e.g. a toothed gear, with a gearwheel that interacts with a rack rail, or with two interacting gearwheels. For example, the rack rail is associated with the extension part, wherein the gearwheel meshes with the rack rail and can drive the extension part in this way. The gearwheel is e.g. arranged on the pivot shaft or a separate drive shaft.

According to an alternative or in addition to a toothed gear, the transmission device comprises a spindle gear with a spindle and a spindle nut. E.g. the spindle is supported rotatably on the base part and the extension part comprises a spindle nut, which is fixedly connected to the extension part and engages with the thread of the spindle. According to an alternative implementation, the spindle nut can also be supported rotatably on the base part and the spindle is connected fixedly to the extension part. The spindle or the spindle nut can be driven e.g. by means of a toothed gear.

According to another alternative embodiment, a gearwheel interacts with a flexible element such as a chain, cable or toothed belt, wherein the flexible element is arranged so that on the rotary movement of the drive gearwheel, which meshes with a gearwheel connected to a winding roller, the flexible element is wound on the winding roller, so that the extension part is movable between the base position and the extended position. The flexible element is connected to the extension part and via a deflection to the winding roller, which is associated with the base part.

Another alternative embodiment provides a friction gear, wherein a friction wheel driven by the drive meshes with a friction track of the extension part, so that the extension part is movable between the base position and the extended position.

The drive force for the relative movement between the extension part and the base part acts on the extension part e.g. at a distance from the pivot axis. In this way a torque that executes the pivoting movement can be produced in the wing.

In the first pivot position e.g. a force preventing the relative movement between base part and extension part is greater than a force causing the pivoting movement. In the first pivot position, e.g. the weight force of the extension part counteracts a relative movement between base part and extension part. Means can be provided that counteract the relative movement between base part and extension part. Influence can be exerted in this way on the sequence of movements such that the rotary movement of the base part takes place before the translatory movement of the extension part relative to the base part.

A spring loads e.g. the extension part in the base position relative to the base part. The spring constitutes a means with which the extension part is loaded in the base position relative to the base part so that a relative movement is counteracted. Alternatively or in addition, e.g. a spring can load the base part in the second pivot position in order to control the order of rotatory movement of the base part and translatory movement of the extension part.

The base part has e.g. first guide means and the extension part has second guide means for movably supporting the extension part on the base part. The guide means comprise e.g. plain bearing means with which the extension part is guided movably on the base part. Alternatively, other common bearing assemblies, such as e.g. ball and roller bearing assemblies, can also be considered. The bearing means are designed e.g. so that the extension part is held undetachably on the base part.

At least one end position of the wing relative to the base is defined e.g. by means of at least one stop face. The head part has e.g. at least one stop face, which interacts with at least one counterface of the wing, wherein in the first pivot position and/or in the second pivot position the stop face and the counterface are in contact. In the second pivot position of the base part, the interaction of the stop face with the counterface causes a counter-torque, which is responsible for the start of the translatory movement of the extension part relative to the base part.

The equipment part comprises two wings, for example. It is then possible e.g. depending on the application to provide each of the wings with a loudspeaker device and in this way to obtain a stereo effect. Alternatively or in addition, the option exists, for example, of resting on both wings.

The at least one wing comprises e.g. a loudspeaker device with at least one loudspeaker, wherein the loudspeaker is connectable to an audio system of the vehicle.

The equipment part is e.g. a headrest, which has a head part as well as a holding device for holding the head part on a backrest of a vehicle seat, wherein the head part forms the base. Wings are mounted on the head part on both sides of the head part. The wings are adjustable e.g. in a plane that is parallel to a sagittal plane of a seat occupant located in a vehicle seat. Alternatively, the pivot plane of the wings can also form an obtuse angle with the sagittal plane. A center line of the wing is e.g. directed approximately vertically upwards or downwards with respect to the pivot axis in the first pivot position. In this position the side view and movement freedom of the seat occupant is not restricted. As long as the extension part is arranged in the base position, it takes up little space.

When the wings are located in the second pivot position and the extension part in the extended position in the use position, the wings project e.g. approximately horizontally forward. In this way e.g. a loudspeaker device arranged in particular in the extension part can be brought into a use position in which the loudspeaker assumes an advantageous position with respect to the seat occupant.

According to an alternative, the equipment part is e.g. an armrest, wherein a backrest of a vehicle seat or a separate pedestal connected to the bodywork of the vehicle forms the base and wherein the wing forms the armrest. The wing can then be stored in a space-saving manner laterally on the backrest of the vehicle seat or in a recess of the backrest when the wing is in the first pivot position and the extension part is in the base position. When in use e.g. the armrest can be pivoted into the second pivot position and the extension part moved into the extended position.

Two exemplary embodiments of the invention are described by way of example in the following description of the figures, also with reference to the schematic drawings. Here for the sake of clarity—even if different exemplary embodiments are concerned—identical or comparable parts or elements or regions are designated by the same reference characters, in some cases with the addition of small letters.

Features which are only described, depicted or disclosed in regard to one exemplary embodiment can be provided in the context of the invention also in the case of any other exemplary embodiment of the invention. Modified exemplary embodiments of this kind are also comprised by the invention, even if they are not depicted in the drawings.

All disclosed features are in themselves fundamental to the invention. Also included fully in terms of content in the disclosure of the application hereby are the disclosure content of the printed publications cited and of the described devices of the prior art, also for the purpose of including individual or several features of the subjects disclosed there in one or in several claims of the present application. Such modified exemplary embodiments are also comprised by the invention, even if they are not depicted in the drawings.

There is shown:

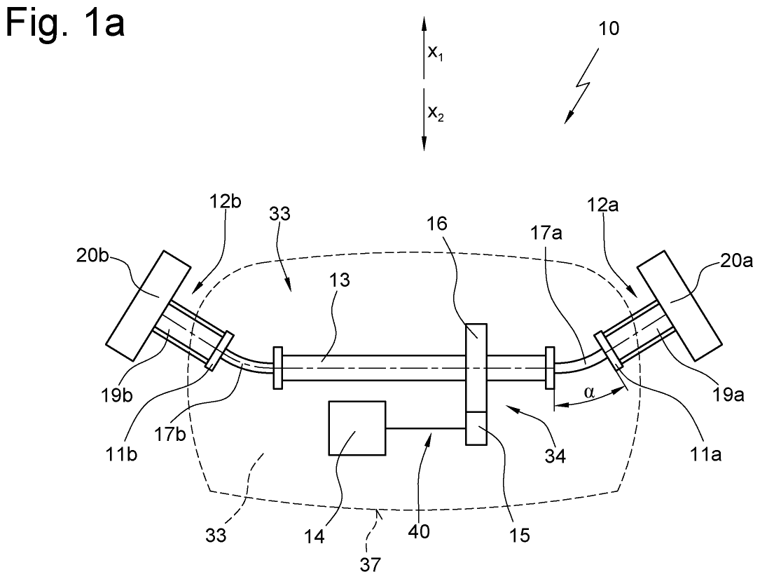

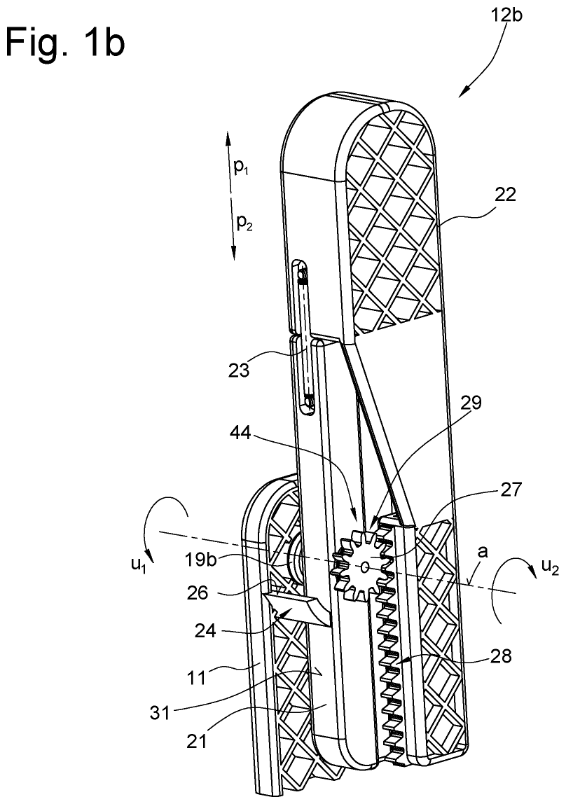

FIG. 1a a schematic plan view of a head rest with two wings,

FIG. 1b a depiction in perspective of a wing in the non-use position,

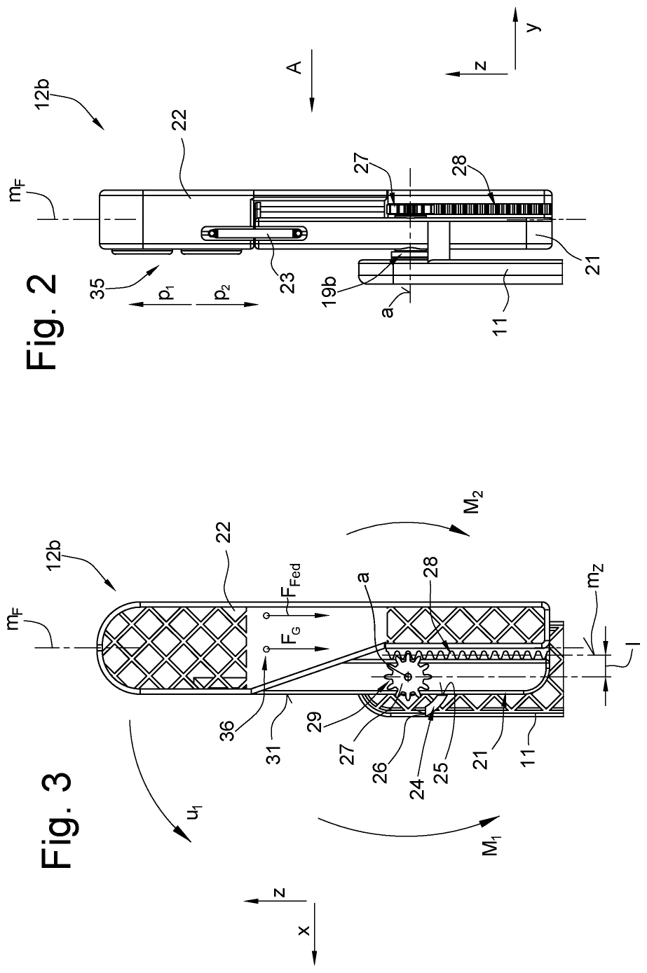

FIG. 2 a front view of the wing according to FIG. 2,

FIG. 3 a view according to view arrow A in FIG. 2,

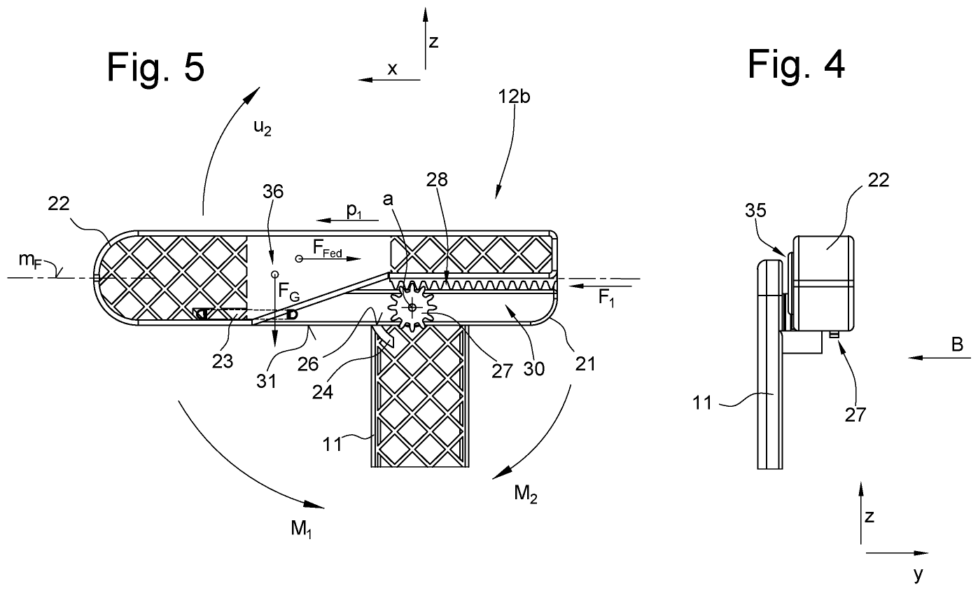

FIG. 4 a front view of the wing in the intermediate position, wherein the wing was pivoted between a first position and a second position,

FIG. 5 a view according to view arrow B in FIG. 4,

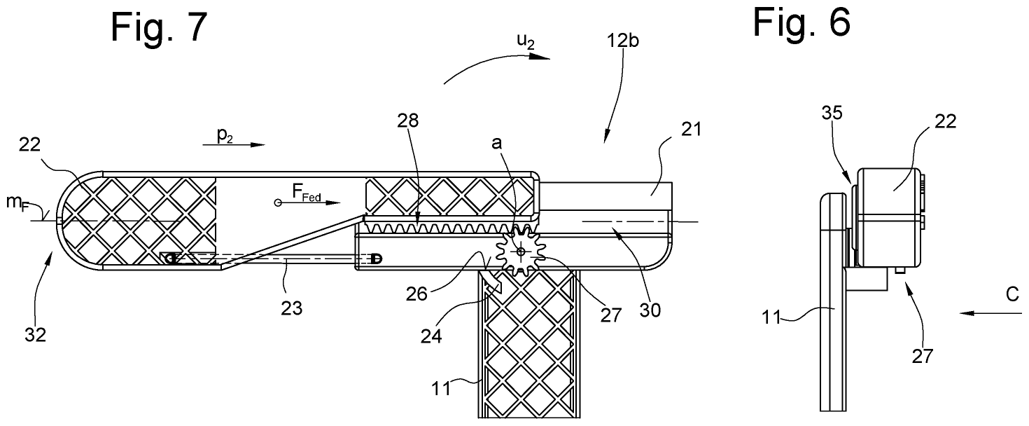

FIG. 6 a front view of the wing in the use position,

FIG. 7 a view according to view arrow C in FIG. 6,

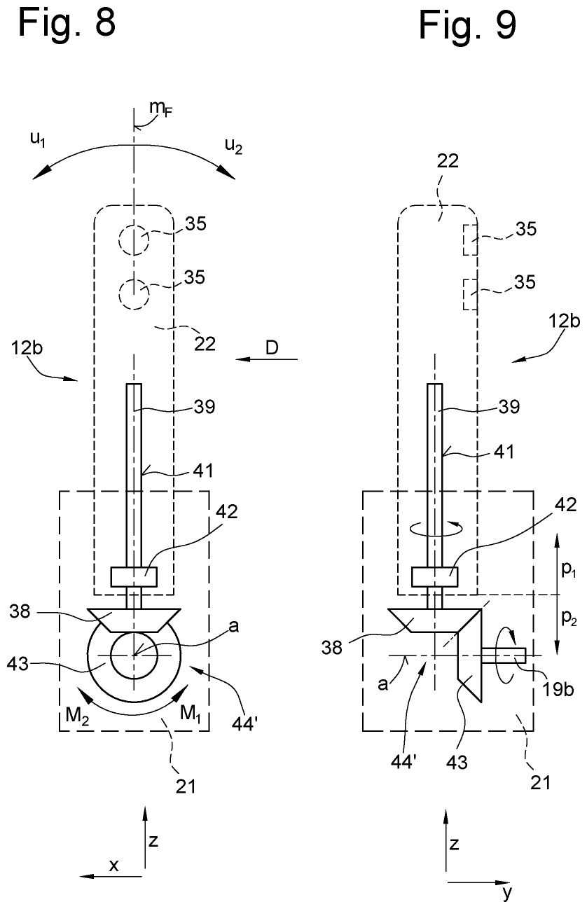

FIG. 8 a view of a second embodiment of the transmission for driving the wing,

FIG. 9 a view according to view arrow D in FIG. 8.

The equipment part in the present exemplary embodiment is a headrest. The equipment part as a whole is designated by the reference character 10 in the figures. The headrest comprises a base 11, here in the form of a head part 33 with a head contact surface 37. The head part 33 is indicated here only by means of a dashed line. The head part 33 is mounted detachably, e.g. by means of a holding device, on a backrest of a vehicle seat or is e.g. part of an integral seat. The attachment of the head part 33 is not important here.

Mounted pivotably on the head part 33 are two wings 12a and 12b. The wing 12a is provided with an arm 20a and the wing 12b with an arm 20b. The wings 12a and 12b serve to adjust e.g. a loudspeaker device 35 provided on the respective wing 12a and 12b and/or a microphone between a use position and a non-use position. According to an alternative, only one wing could also be mounted on the head part 33.

Each wing 12a and 12b comprises a base part 21 and an extension part 22. The extension part 22 is movable in a translatory manner relative to the base part 21. A movement of each wing 12a and 12b between a non-use position and a use position is composed of a pivoting movement of the wings 12a and 12b between a first pivot position and a second pivot position as well as of a movement of each extension part 22 between a base position and an extended position. In the base position, the base part 21 and the extension part 22 are arranged nested. In the extended position, the base part 21 and the extension part are located in an extended arrangement in which the length of the respective arm 20a and 20b is longer with reference to the base position.

The drive of the movement of the two wings 12a and 12b takes place by means of a central drive device 40. The drive device 40 comprises a motor drive 14, e.g. an electric motor, and drive elements 15 and 16 of a transmission device 34, which drives a shaft 13. The shaft 13 can be driven by the drive 14 in both directions of rotation.

The drive device 40 also comprises transfer elements 17a and 17b for transferring the movement of the shaft 13 to drive shafts 19a and 19b of the wings 12a and 12b. The transfer elements 17a and 17b are depicted purely schematically here. They can be formed by interacting bevel gears of the shaft 13 and the drive shafts 19a and 19b of the wings 12a and 12b. Alternatively e.g. cardan joints could be provided between the shaft 13 and the drive shafts 19a and 19b. In the case that the drive shafts 19a and 19b are in line with the shaft 13, i.e. not as depicted in FIG. 1a, center lines m2 of the drive shafts 19a and 19b form an angle 0°<α<180° with the center line m1 of the shaft 13, the shaft 13 can be used directly to drive the drive shafts 19a and 19b. This means that the transfer elements 17a and 17b can be eliminated.

The shaft 13 has a rotary connection to the transfer elements 17a and 17b such that the shaft 19a of the wing 12a can be driven by the transfer element 17a and the shaft 19b of the wing 12b can be driven by the transfer element 17b. Both wings 12a and 12b are always driven by the shaft 13 at the same time.

As the wings 12a and 12b are basically constructed identically, only the wing 12b is described below (see FIG. 1b).

The base 11 serves as a bearing for the shafts 19a and 19b. The base part 21 of the wing 12a is supported on the shaft 19b with the pivot axis a so as to be rotatable in the directions u1 and u2 relative to the shaft 19b. An end region of the shaft 19b is provided according to FIG. 1b with a gearwheel 27, which has teeth 29. The gearwheel 27 meshes with a toothed bar 28, which is arranged fixedly on the extension part 22 of the wing 12a. A transmission 44 is formed in this way with the gearwheel 27 and the toothed bar 28.

In the present exemplary embodiment, the pivot axis a is the drive shaft 19b at the same time. This does not necessarily have to be the case. The drive can also be independent of the pivot axis. What is important is the production of a torque about the pivot axis.

The extension part 22 is supported on the base part 21 movably relative to the base part 21 in the directions p₁ and p₂ in a translatory manner between the base position and the extended position. First guide means of the base part interact with second guide means of the extension part and form a guide device 30, which guarantees a movable bearing arrangement.

A spring 23 loads the extension part 22 in the base position relative to the base part 21 with a spring force F_{fed}. The spring 23 has the purpose of influencing the sequence of movements, i.e. the pivoting movement and the translatory movement of the wings 12a and 12b, so that these are carried out consecutively. On account of the spring 23, first the pivoting movement and thereafter the translatory movement of the extension part 22 take place during the movement from the non-use position to the use position in the present exemplary embodiment.

The drive device for moving the extension part 22 relative to the base part 21 can alternatively be designed in another way. What is substantial is that the drive device is used at the same time for the pivoting movement of the wing and the movement of the extension part between the base position and the extended position.

According to an alternative implementation to the embodiment depicted in FIGS. 1a to 7, a friction drive, for example, would also be conceivable in which the gearwheel 27 is replaced by a friction wheel and the toothed rail 28 is replaced by a friction track with which the friction wheel is in contact.

Also conceivable is e.g. a drive of a spindle supported rotatably on the base part 21, which spindle engages in a spindle nut of the extension part. This embodiment is described in greater detail further below.

The base 11 has a stop 24, which forms stop faces 25 and 26 (see e.g. FIG. 1b). In the first pivot position of the wing 12b according to FIGS. 1b to 3, a counterface 31 of the wing 12a, here of the base part 21, is in contact with the stop face 25 and prevents further rotary movement in direction u₂. A longitudinal center line m_{F} of the wing 12b is arranged approximately vertically. What is important in this case is not an exactly vertical arrangement, but an arrangement that does not restrict the lateral movement space of the seat occupant.

During driving of the shaft 13 in a first direction of rotation, the drive shafts 19a and 19b are driven. This leads to driving of the gearwheel 27 in direction of rotation u₁, wherein a torque M1 is produced about the pivot axis a on which the base part 21 is supported so as to be freely rotatable. It is to be seen in FIG. 3 that a spacing I is formed between a center line m_{z} of the toothing of the toothed rail 28 and the pivot axis a. The force applied by the gearwheel 27 to the toothed bar 28 thus causes the torque M1 in direction u₁ in the base part 21.

The spring force of the spring 23 is sufficiently strong that no relative movement takes place between the base part 21 and the extension part 22 before the pivoting movement from the first pivot position to the second pivot position has been completed.

The torque M1 in this position is greater than a torque M2 which is created by the weight force F_{G} in a center of gravity 36 of the wing 12b. The wing 12b therefore pivots about the axis of rotation a in direction u₁. As soon as the wing 12b has pivoted a certain angle of rotation in direction u₁, the weight force F_{G} supports the torque M1.

The wing 12b pivots together with the base part 21 and the extension part 22 from a first pivot position in direction u₁ until the counterface 31 of the wing 12b comes into contact with the stop face 26 (see FIG. 5). The wing 12b is then located in the second pivot position. Further pivoting in direction u₁ is not possible.

In the second pivot position, the force F1 caused by the torque M1 on the gearwheel 27 exceeds the holding force F_{Fed} of the spring 23 and the extension part 22 moves relative to the base part 21 in direction p₁. Here the gearwheel 27 rolls on the toothing 28 until it has reached the position according to FIG. 7, which is defined by stops, not depicted, of the base part and the extension part. The guide device 30 guides the movement of the extension part 22 here relative to the base part 21.

When the end position of the extension part 22 according to FIG. 7 is reached, the extension part 22 is in the extended position.

In the use position according to FIG. 7, the center line m_{F} of each wing 12a and 12b is pivoted by approximately 90° with regard to the base position and the base part 21 is located in the second pivot position. The extension part 22 is arranged in the extended position and a free end region 32 of the extension part 22 projects approximately horizontally forwards, approximately in direction x1.

To transfer the wing 12b from the use position to the non-use position, the shaft 13 is driven in a second direction of rotation u₂, which is a reverse direction with respect to the first direction of rotation. The gearwheel 27 then moves in direction of rotation u₂, wherein the spring force F_{fed}, which likewise acts in direction p₂, supports the movement of the extension part 22. In this case the force ratio is such that the forces that cause the translatory movement are greater than the forces that cause the rotary movement. The extension part 22 moves from the position according to FIG. 7 relative to the base part 21 in direction p₂ until the extension part 22 has reached the position according to FIG. 5. The base position of the extension part 22 relative to the base part 21 according to FIG. 5 is determined by stops, not depicted, of the base part 21 and the extension part 22.

During further driving of the gearwheel 27 in direction u₂, the wing 12b is pivoted in direction u₂ until the non-use position according to FIG. 3 is reached. This is defined by the contact of the stop face 25 and the counterface 31. In the non-use position, the center line m_{F} of the wing 12b is arranged approximately vertically.

A second exemplary embodiment is depicted in FIGS. 8 and 9.

The movement of the base part 21 and the extension part 22 takes place according to the first exemplary embodiment. The construction of the wing 12b is also identical apart from the transmission 44, which is replaced by a transmission 44′. Instead of the gearwheel 27, a bevel gear 43 is formed, which is driven by the shaft 19b and meshes with a bevel gear 38, which is connected in a torque-proof manner to a spindle 39. The spindle 39 is supported rotatably on the base part 21. A spindle nut 42, which is connected fixedly to the extension part 22, engages with a thread 41 of the spindle 39. During driving of the bevel gear 38 by means of the shaft 19b, a torque M1 is produced about the axis of rotation a in direction u₁, which torque is responsible for pivoting of the wing 12b in direction u₁.

On account of the force ratio between the transmission parts, which can be modified e.g. via the pitch of the spindle gear, influence can be exerted on the sequence of pivoting movement and translatory movement. In this case the process of pivoting the wing 12b from the first pivot position to the second pivot position takes place e.g. before the movement of the extension part 22 between the base position and the extension position. For example, the pitch of the thread of the threaded spindle can be designed for this such that a suitable resistance exists to a translatory movement of the extension part before the rotatory movement of the base part. In addition or alternatively, the spring 23 (not shown in FIGS. 8 and 9) can be designed as in the first exemplary embodiment and load the extension part 22 in the base position. To move the wing 12b into the non-use position, the drive shaft 19b is moved in the reverse direction u₂. The headrest 10 and the wing 12b are otherwise designed as in the first exemplary embodiment.

In a variant of the second exemplary embodiment depicted previously, the bevel gear 38 is connected in a torque-proof manner to the spindle nut 38, which is supported rotatably in the base part 21. The spindle 39′ is fixedly connected to the extension part 22. During driving of the spindle nut 38 in direction u₁, a torque M1 is produced in direction u₁ in the same way.

1-15. (canceled)

16. An equipment part for a vehicle, comprising: a wing device comprising at least one wing, wherein the wing is supported pivotably about a pivot axis between a first pivot position and a second pivot position and wherein the wing comprises a base part and an extension part that is supported movably in a translatory manner relative to the base part between a base position and an extended position; and an adjusting device comprising at least one motor drive and a transmission for executing the pivoting movement as well as the translatory movement of the wing, wherein the transmission is configured to convert a rotary movement of the drive to a translatory movement of the extension part, wherein a torque about the pivot axis is produced in the base part, with which torque the wing is pivotable between the first pivot position and the second pivot position.

17. The equipment part according to claim 16, wherein the base part is supported pivotably on a base.

18. The equipment part according to claim 16, wherein the base part forms a pivot joint with the pivot axis.

19. The equipment part according to claim 16, wherein the pivot axis is simultaneously a drive shaft of a drive device.

20. The equipment part according to claim 16, wherein a drive force acts on an extension part spaced from the pivot axis.

21. The equipment part according to claim 16, wherein the transmission comprises a gear transmission with a gearwheel, that interacts with a toothed bar.

22. The equipment part according to claim 16, wherein the transmission comprises a spindle transmission with a spindle and a spindle nut.

23. The equipment part according to claim 16, wherein the transmission forms a chain transmission, a toothed belt transmission or a belt transmission, wherein the transmission is driven such that a torque is produced in the base part.

24. The equipment part according to claim 16, wherein in the first pivot position, a force preventing relative movement between the base part and the extension part is greater than a drive force for driving the translatory movement.

25. The equipment part according to claim 16, further comprising a spring arranged to load the base part and the extension part in the base position.

26. The equipment part according to claim 16, wherein the base part has first guide means and the extension part has second guide means for supporting the extension part movably on the base part.

27. The equipment part according to claim 17, wherein the base has at least one stop face that interacts with a counterface of the wing, wherein in a non-use position and/or in a use position the stop face and the counterface are in contact.

28. The equipment part according to claim 16, wherein the wing device comprises two wings.

29. The equipment part according to claim 16, wherein the wing has a loudspeaker device with at least one loudspeaker, wherein the loudspeaker is connectable to an audio system of the vehicle.

30. The equipment part according to claim 17, wherein the equipment part is a headrest or an armrest, wherein the base is formed by a head part of the headrest or by a backrest of a vehicle seat.
